(19) United States
(12) Patent Application Publication
(10) Pub. No.: US 2009/0033901 A1
(43) Pub. Date: Feb. 5, 2009

(54) DRIVING APPARATUS AND EXPOSURE APPARATUS USING THE SAME AND DEVICE MANUFACTURING METHOD

(75) Inventor: Hirohito Ito, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/181,215

(22) Filed: Jul. 28, 2008

(30) Foreign Application Priority Data
Aug. 1, 2007 (JP) 2007-200906

(51) Int. Cl. G03B 27/42

(52) U.S. Cl. 355/53

(57) ABSTRACT

A driving apparatus for driving an object in a vacuum environment includes a first chamber whose interior is maintained in a vacuum environment, a mover configured to load the object, and a stator, wherein the mover includes one or more magnets, the stator includes one or more coils. The mover moves along an upper surface of the stator in a non-contact state therewith when an electric current is applied to the coil or coils. The upper surface of the stator is a part of a partition wall of the first chamber.

### BACKGROUND OF THE INVENTION

1. Field of the Invention

The present invention relates to a driving apparatus that drives an object in a vacuum environment. More particularly, the present invention relates to an exposure apparatus that moves a substrate or an original plate using the driving apparatus. The present invention further relates to a device manufacturing method using the exposure apparatus.

2. Description of the Related Art

Conventionally, a reduced projection exposure apparatus using ultraviolet light has been used to make an exposure with finely miniaturized circuit patterns to produce semiconductor elements. The minimum dimension of circuit patterns transferable by the reduced projection exposure apparatus is proportional to a wavelength of light used for exposure. Thus, the wavelength of exposure light has been shortened along with miniaturization of the circuit pattern. Presently, it has become common to use an ArF excimer laser (whose wavelength is 193 nm) to produce the light used in the reduced projection exposure apparatus.

However, light of a wavelength in the ultraviolet region cannot support future miniaturization of semiconductor elements any more. Therefore, a reduced projection exposure apparatus using extreme ultraviolet light (EUV light) that has a shorter wavelength of about 10 to 15 nm is developed.

Since the EUV light is greatly absorbed by gases such as the atmosphere, it is necessary to maintain in a high-vacuum state the space through which the EUV light propagates. It is necessary to maintain pressure of at least 10⁻¹ Pa or less, desirably 10⁻³ Pa or less in most of the space through which the EUV light propagates. It is also necessary to maintain partial pressure of gases having low light transmissivity such as oxygen and water as low as possible. In cases where components containing carbon remain in the space, a problem will arise that carbon adheres to a surface of an optical element due to irradiation with the EUV light and the adhering carbon absorbs the EUV light. It is considered that the partial pressure of molecules containing carbon needs to be maintained at least at 10⁻⁴ Pa or less, desirably at 10⁻⁶ Pa or less, within a space where an optical element which is irradiated with the EUV light is placed to prevent the carbon from adhering to the surface of the optical element.

A current exposure apparatus in general has a reticle stage that mounts a reticle as an original plate of a circuit pattern and a wafer stage that mounts a wafer onto which a circuit pattern is printed. An exposure method known as step-and-scan has become mainstream. In this method, exposure processing is conducted by synchronizing the reticle stage and the wafer stage with each other at a speed ratio proportional to a reduction rate and repeatedly performing scanning. Accordingly, both the reticle stage and the wafer stage have mechanisms for enabling the movement at high speed and in high precision. For example, these stages have a position sensor for detecting a stage position in high precision, such as a laser interferometer, and a linear motor that generates a great thrust force for moving a stage at high speed.

Since an EUV exposure apparatus needs to expose wafers in a vacuum, a reticle stage and a wafer stage are installed in a vacuum chamber. However, this structure requires increase of the interior capacity and the interior surface area of the vacuum chamber, so that it becomes difficult to maintain the necessary degree of vacuum. Further, a stage installed inside the vacuum chamber has a complicated mechanism and a large surface area. Such a stage is made of various materials including organic substances. Particularly, a driving mechanism such as a linear motor includes coils and magnets as well as cables for supplying electric power. As a consequence, it becomes more difficult to maintain the degree of vacuum owing to outgas from these materials.

A mechanism for maintaining the degree of vacuum inside a vacuum chamber in a stage apparatus installed inside the vacuum chamber is discussed in Japanese Patent Application Laid-Open No. 2005-57289. FIG. 4 illustrates a stage apparatus discussed in Japanese Patent Application Laid-Open No. 2005-57289. A stage apparatus 400 has a first driving unit mover 411 integrated with a stage moving unit, a second driving unit mover 412 integrated with a first driving unit stator 410, and a second driving unit stator 413. A partition wall 415 is provided between the first driving unit mover 411 and the first driving unit stator 410. With the partition wall, the components arranged below the first driving unit stator 410 are separated from a stage moving unit that mounts reticles or wafers. As a result, a volumetric capacity and an interior surface area of a vacuum chamber which includes the stage mounting the reticles or the wafers are reduced and it becomes easy to maintain and control a degree of vacuum inside the vacuum chamber. Further, deterioration of the degree of vacuum due to outgas from the first driving unit stator 410, the second driving unit mover 412, and the second driving unit stator 413 can be reduced.

However, the partition wall 415 must not contact the first driving unit mover 411 and the first driving unit stator 410 in the stage apparatus discussed in Japanese Patent Application Laid-Open No. 2005-57289. It is also necessary to minimize intervals between the first driving unit mover 411 and the first driving unit stator 410 to increase driving efficiency of the first driving unit mover 411. Therefore, the stage apparatus discussed in Japanese Patent Application Laid-Open No. 2005-57289 needs an additional mechanism to maintain a partition wall interval, such as a means for providing pressure difference at both sides of the partition wall 415 or an air bearing mounted between the first driving unit stator 410 and the partition wall 415. Further, a control apparatus that controls these mechanisms in high precision is needed to prevent the first driving unit stator 410 from contacting the partition wall 415. Therefore, structure of the apparatus becomes complicated and the manufacturing costs are increased.

### SUMMARY OF THE INVENTION

The present invention is directed to simplifying a structure of a driving apparatus that drives an object in a vacuum environment.

According to an aspect of the present invention, a driving apparatus that drives an object in a vacuum environment includes a first chamber whose interior is maintained in a vacuum environment, a mover configured to load the object, and a stator, wherein the mover includes one or more magnets and the stator includes one or more coils. The mover moves an upper surface of the stator in a non-contact state when electric currents is applied to the coil or coils, and the upper surface of the stator is a part of the partition wall of the first chamber.

According to another aspect of the present invention, a driving apparatus that drives an object in a vacuum environment includes a mover configured to load the object, and a stator, wherein the mover includes one or more magnets, and the stator includes one or more coils. The mover moves an upper surface of the stator in a non-contact state when an electric current is applied to the coil or coils. The driving apparatus includes first and second chambers whose interiors are maintained in a vacuum environment, wherein the upper surface of the stator is a part of the partition wall of the first chamber, and a side and a bottom part of the stator is a part of the partition wall of the second chamber.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the present invention and, together with the description, serve to explain the principles of the present invention.

FIG. 1 illustrates an exposure apparatus equipped with a driving apparatus according to a first exemplary embodiment of the present invention.

FIG. 2 illustrates an exposure apparatus equipped with a driving apparatus according to a second exemplary embodiment of the present invention.

FIG. 3 illustrates an exposure apparatus equipped with a driving apparatus according to a third exemplary embodiment of the present invention.

FIG. 4 illustrates a conventional stage apparatus.

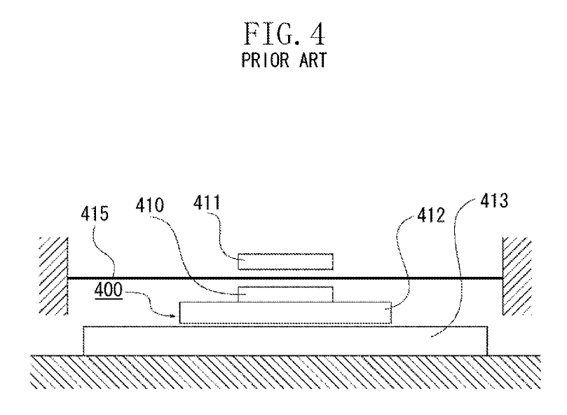

### DETAILED DESCRIPTION OF THE EMBODIMENTS

Various exemplary embodiments, features, and aspects of the invention are described in detail below with reference to the drawings.

### First Exemplary Embodiment

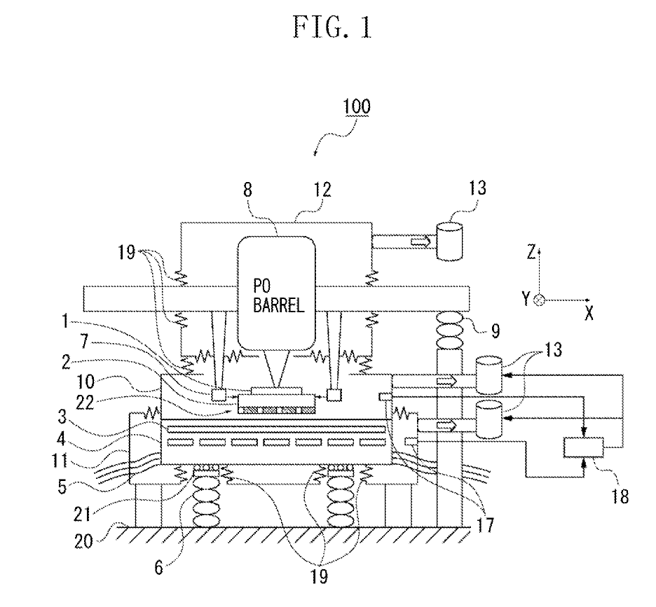

FIG. 1 illustrates an exposure apparatus 100 equipped with a driving apparatus according to the first exemplary embodiment of the present invention. The exposure apparatus 100 includes an illumination optical system (not illustrated), a driving apparatus (not illustrated) that drives a reticle (original plate), a projection optics (PO) barrel 8 that has a projection optical system on the inside, and a driving apparatus that drives a wafer 1 (substrate). The driving apparatus includes a planar motor 22 including a mover 2 and a stator 4. The mover 2 on which the wafer 1 is loaded includes a plurality of permanent magnets in its lower side. The stator 4 includes a plurality of stator coils 3 on the inside. A Lorentz force for driving the mover 2 is generated by energizing the stator coils 3. The stator 4 may include a pipe line through which a cooling fluid flows, around the stator coils 3 to cool the coils 3.

An upper surface of the stator 4 is provided between the stator coils 3 and the mover 2 to prevent the stator coils 3 from contacting the mover 2. The upper surface of the stator 4 also has, for example, a function of forming a cooling pipe around the stator coils 3. The upper surface of the stator 4 is a plane, and the mover 2 can (two-dimensionally) move along the plane in a non-contact state with the stator 4. For example, the mover 2 includes hydrostatic bearings (not illustrated), so that the mover 2 can be floated from the upper surface of the stator 4 by ejecting a gas from the hydrostatic bearings. When the hydrostatic bearings are used in a vacuum atmosphere, a mechanism for recovering the gas ejected from the hydrostatic bearings is provided. Further, the mover 2 can be floated from the upper surface of the stator 4 by a magnetic force.

The stator 4 is supported by a base 20 via stator mounts 6. The stator mounts 6 block vibration transmission to the stator 4 from a floor on which the apparatus is installed via the base 20. Further, the stator mounts 6 reduce a reaction force generated by driving the mover 2 and transmitted to the floor via the base 20.

A position of the mover 2 is measured by a position measuring unit 7. As the position measuring unit 7, a laser interferometer is used, although other types of sensors can alternatively be used in accordance with the present invention.

The planar motor 22 drives the mover 2 in a planar direction (an XY direction and a rotation direction about a Z axis), and generates a force (in a Z direction) for supporting a self-weight of the mover 2. The planar motor 22 can also generate a force for controlling an inclination drive (rotation directions around an X-axis and around a Y-axis) of the mover 2. Such structure allows the exposure apparatus 100 to move the mover 2 on which the wafer 1 is loaded to an exposure position and change an orientation (inclination amount) of the mover 2 to perform exposure in a proper state. Generation of a force in the planar motor 22 is controlled by a control apparatus (not illustrated) that controls an electric current applied to the stator coils 3.

Cables for supplying electric power are connected to the stator coils 3. Since the numerous stator coils 3 are laid on a movable range of the mover 2, many cables for supplying electric power to the stator coils 3 are used. Further, pipes for supplying and collecting the cooling fluid are also connected to the stator coils 3 to cool down a heat generated in the coils 3. Because coils are installed on the stator 4 side and magnets are installed on the mover 2 side, wire connections of cables and pipes 5 are not needed on the mover 2 side. Thus, the mover 2 is not affected by disturbances caused by bending and dragging of the wire arrangement.

Distances between the magnets and the coils should be as short as possible to increase driving efficiency. Therefore, the magnets are installed on a surface of the mover 2 facing the stator 4. The stator coils 3 are installed on the upper side of the stator 4 facing the mover 2. The upper surface of the stator 4 is mounted on the surface of the stator coils 3 at the mover 2 side as described above. A material of the upper surface of the stator 4 is desirably a non-magnetic material to avoid disturbing of a magnetic circuit of the planar motor 22. The material is also desirably a nonconductive material to avoid generating eddy-current losses.

In the EUV exposure apparatus, an exposure needs to be performed in a vacuum environment. A stage chamber 10 (a first chamber) is configured by enclosing with partition walls a space within which the wafer 1 and the mover 2 move. The vacuum environment can be produced inside the stage chamber 10 by evacuating air using exhaust units 13, such as a dry pump and a turbo-molecule pump. As the vacuum environment, pressure in the stage chamber is desirably set at 10⁻¹ Pa or less, more desirably 10⁻³ Pa or less.

Organic substances may be used in the stator coils 3 and the cables and pipes 5 to maintain flexibility. If such members were to be arranged in the stage chamber 10, outgas components which are obstacles to the exposure could be increased in the stage chamber 10. For example, in such an arrangement, if the planar motor 22 has many stator coils 3 using organic substances and many cables and pipes 5 using organic substances, then a lot of outgas components could be released. This is because a surface area from which outgas is released increases when more stator coils 3 or more cables and pipes 5 are used. In addition, the stage chamber 10 would need a large capacity if a stator of a planar motor were to be installed in the stage chamber 10 because a stator is generally large in size. As a result, it would become difficult to maintain a required vacuum environment in the stage chamber 10. Therefore, to address these issues, in the present exemplary embodiment, the upper surface of the stator 4 is used as a part of the partition wall of the stage chamber 10.

Thus, the members inside the stator 4 can be arranged outside of the stage chamber 10, so that the outgas from these members will not affect the inside of the stage chamber 10. Examples of these members include the stator coils 3 and the cables and pipes 5 to be connected to the stator 4. At least a part or more (desirably all) of these members are arranged outside of the stage chamber 10. Particularly, it is desirable that the cables and pipes 5 be arranged outside the stage chamber 10 since the planar motor 22 includes the stator coils 3 that have many coil conductive wires.

Arranging the members of the stator 4 outside the stage chamber 10 improves the maintenance of a vacuum inside the stage chamber 10, for example, because the volume inside the stage chamber 10 can be drastically reduced. While the present exemplary embodiment uses the overall upper surface of the stator 4 as a part of the partition wall, alternatively only a region including a moving range of the mover 2 along the upper surface may be used as a part of the partition wall.

According to the present exemplary embodiment, the planar motor 22 is used as a driving unit of the wafer stage. Since the partition wall is integrally fixed with the stator coils 3 and the stator 4, there is no need to mount the partition wall which is structurally independent from the stator 4 between the mover 2 and the stator coils 3, and the stage chamber 10 can be realized with a simple structure. Further, the intervals between the magnets and the coils can be made narrow because no independent partition walls exist between the mover 2 and the stator coils 3, and thus driving efficiency of the planar motor 22 can be very high. Moreover, the surface area of walls inside the stage chamber can be reduced relative to prior art.

The partition wall of the stage chamber 10 can include a bellows 19 connected to the stator 4. Thus, the bellows 19 can prevent deformation of the stator 4 even if the stator 4 vibrates.

On the other hand, the stator 4 may be deformed by pressure difference with the atmosphere when the vacuum environment is established inside of the stage chamber 10. In cases where a deformation amount on the upper surface of the stator 4 facing the mover 2 increases, the mover 2 contacts the stator 4, and movement of the stage can be disturbed. More specifically, in this embodiment, the deformation amount of the stator 4 needs to be at least less than the interval between the mover 2 and the stator 4 within the area where the mover 2 faces the stator 4.

To address these deformation issues, the stator 4 can be installed inside a stator chamber 11 (a second chamber) that has an internal space separated from the stage chamber 10, so that pressure in the stator chamber 11 can be reduced to a low vacuum by the exhaust unit 13. Thus, the pressure difference applied to the stator 4 can be reduced and the deformation amount of the stator 4 can be reduced. As stiffness of the stator 4 is generally high enough, inner pressure of the stage chamber 10 and the stator chamber 11 may roughly match with each other so that the movement of the mover 2 cannot be disturbed. Although an acceptable upper limit on the pressure difference between the stator chamber 11 and the stage chamber 10 depends on the stiffness of the stator 4 and a pressure reception area of the stator 2, a pressure difference of nominally 10 Pa is acceptable. The inner pressure of the stator chamber 11 is set higher than the inner pressure of the stage chamber 10. Thus, performance of the exhaust unit 13 at the stator chamber 11 side can be lowered. Outgas components in the stator chamber do not need to be considered because any contamination condition inside the stator chamber 11 does not influence the exposure. In other words, outgassing does not cause a problem even if the cables and pipes 5 pass through the stator chamber 11. Residual gases inside the stator chamber 11 may be replaced by an inert gas such as helium.

Further, a mechanism may be provided to control the inner pressure difference between the stage chamber 10 and the stator chamber 11. A pressure sensor 17 is respectively installed in the stage chamber 10 and the stator chamber 11, and the inner pressures of these chambers are measured. A pressure adjustment unit 18 controls the exhaust unit 13, according to the measured inner pressures of the stage chamber 10 and the stator chamber 11, to keep each of these chambers at a predetermined pressure. Thus, the pressure is controlled to avoid the deformation of the stator 4 and the stator 4 can avoid contact with the mover 2. In an alternative to the embodiment, only the inner pressure of the stator chamber 11 is controlled to set the inner pressure difference between the stage chamber 10 and the stator chamber 11 to be within a predetermined range.

Although the stator chamber 11 can be directly supported on the floor, it is desirable to provide vibration insulation such as the bellows 19 in order to prevent transmission of vibrations to the stage chamber 10 and the stator 4.

The EUV exposure apparatus has a projection optical system including a plurality of reflecting mirrors, and these reflecting mirrors are fixed at predetermined positions in the PO barrel 8. Some of the reflecting mirrors may be adjustable by driving mechanisms. The EUV light emitted from a light source (not illustrated) is reflected by a reticle (not illustrated), led to the projection optical system in the PO barrel 8, and finally forms an image on the wafer 1. The PO barrel 8 is installed within a PO barrel chamber 12 because an internal space of the PO barrel 8 needs to be vacuum. A space of the PO barrel chamber 12 is connected with a space of the stage chamber 10 only at a portion through which the EUV light passes.

The PO barrel 8 supported independently from a stage by PO barrel mounts 9 so that vibrations from a floor and the stage are not transmitted. Further, space between the stage chamber 10 and the PO barrel chamber 12 may be provided with the bellows 19 to insulate vibrations.

A mechanism for reducing influences caused by the reaction force that is generated by driving the mover 2 may be provided. For example, the stator 4 may be supported to be able to move relative to the base 20 due to the reaction force generated by driving the stator 2. Thus, the reaction force of the mover 2 is absorbed by motion of the stator 4, so that no vibration is transmitted to the outside. As a guide unit 21 for guiding the stator 4 to make a movement, a guide mechanism using mechanical bearings, or a non-contact guide using a fluid such as air may be used. The guide unit 21 uses an active or a passive driving mechanism to return the stator 4 to a predetermined reference position. In a case where the movable range of the stator mount 6 is sufficiently large, the stator mount 6 can function as the guide unit 21. In such a case, the stage chamber 10 is connected to the PO barrel chamber 12 by the bellows 19 which can move across the movable range of the stator 4 so that the movement of the stator 4 is not disturbed. In other cases, the bellows 19 may be mounted between the stage chamber 10 and the stator 4.

The exposure apparatus 100 is not limited to the above-described configuration, but can have a different configuration. For example, the exposure apparatus 100 can be applied to a twin-stage structure with two wafer stages as well as to an immersion exposure apparatus.

Although the planar motor 22 uses the Lorentz force according to the present exemplary embodiment, the motor is not limited to the configuration of the present exemplary embodiment. For example, linear pulse planar motor may be applied as long as the inner capacity of the stage chamber 10 is reduced and members of the stator 4 can be arranged outside the stage chamber 10.

As described above, the stage chamber 10 space can have a relatively simple structure since the upper surface of the stator 4 is a part of the partition wall of the stage chamber 10 according to the present exemplary embodiment. Further, contaminated substances can be arranged outside the stage chamber 10 as much as possible by installing the stator 4, the stator coils 3 and the cables and pipes 5 outside the stage chamber 10. Thus, the present invention can reduce the contaminated substances in the stage chamber, improve the degree of vacuum, and simplify the degree of vacuum control.

### Second Exemplary Embodiment

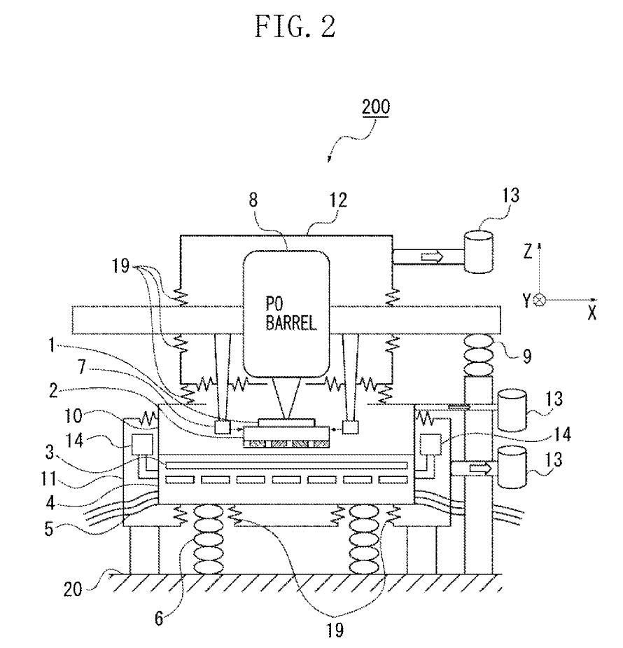

FIG. 2 illustrates an exposure apparatus 200 equipped with a driving apparatus according to the second exemplary embodiment of the present invention. In the present exemplary embodiment, structures that are the same as (or alternatively similar to) those in the first exemplary embodiment are identified with the same reference numerals, and redundant description is avoided.

In the present exemplary embodiment, a mechanism for reducing influences caused by the reaction force for driving is different from the first exemplary embodiment. While the first exemplary embodiment uses the guide unit 21 to enable the stator 4 to make a movement, in the present exemplary embodiment, a driving unit 14 for driving a mass body is attached to the stator 4. A typical structure of the driving unit 14 has a mass body, a non-contact or contact type guide mechanism for guiding the mass body, and a driving portion for driving the mass body. The driving unit 14 drives the mass body in the direction opposite to the moving direction of the mover 2 to set-off the reaction force for the driving of the mover 2, and can avoid transmitting vibrations caused by the reaction force to the outside. In this case, the bellows 19 of the stage chamber 10 may only have a function of insulating the vibrations because the stator 4 does not need to move. Thus, outside the stage chamber 10, a driving unit is installed that drives mass body to exert on the stator 4 a force that resists the force exerted by the mover 2 on the stator 4. As a consequence, contamination of space in which the stages are installed can be suppressed. The mechanism can reduce vibrations owing to the reaction force caused by acceleration and deceleration of the mover 2, and perform the drive in higher precision.

### Third Exemplary Embodiment

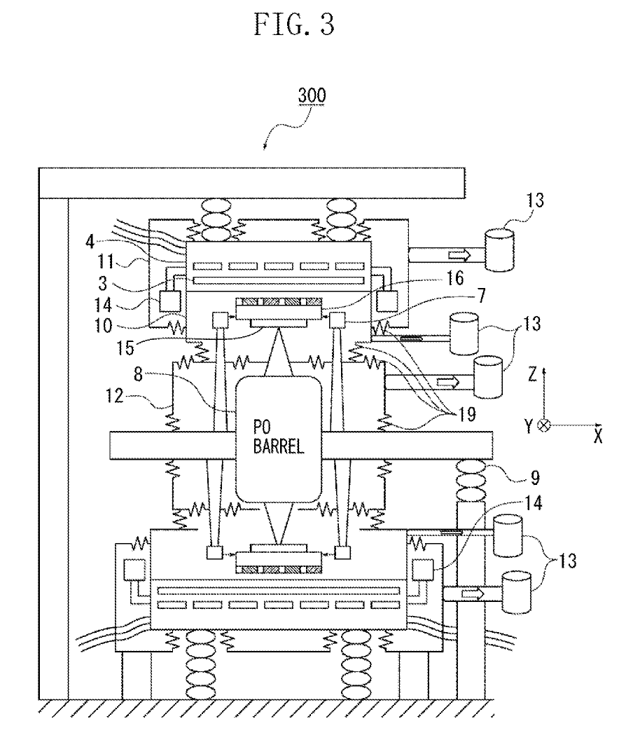

FIG. 3 illustrates an exposure apparatus 300 equipped with a driving apparatus according to the third exemplary embodiment of the present invention. In the present exemplary embodiment, structures that are the same as (or alternatively similar to) those in the first or second exemplary embodiments are identified with the same reference numerals, and redundant description is avoided. The present exemplary embodiment applies the above-described structure to a reticle stage.

Essentially the same structure as for the wafer stage is applied to the reticle stage. However, in this embodiment, the reticle stage is different from the wafer stage in that it has a vertically inverse structure. So, in this embodiment, the reticle stage mover 16 has a reticle 15 loaded downward, and its self-weight is supported to the stator 4 by a force in a Z direction of a motor.

The wafer stage moves in the plane in a wide range. While the reticle stage largely moves in a scanning direction, the reticle stage rarely moves in a direction orthogonal to the scanning. Thus, the inner capacity of space for the stage chambers can be reduced. Although the stator 4 is long in the scanning direction, the stator 4 can be shortened to the extent equivalent to the width of the reticle stage mover 16 in the orthogonal direction. Accordingly, deformation of the stator 4 can be reduced in comparison with the wafer stage. While the present exemplary embodiment uses the driving unit according to the second exemplary embodiment for the driving reaction force, the guide unit according to the first exemplary embodiment may also be used.

### Example of a Device Manufacturing Method

A device (such as a semiconductor integrated circuit element and a liquid crystal display element) is manufactured by the processes of exposing a substrate (such as a wafer and a glass substrate) coated with photosensitive materials using an exposure apparatus according to any of the aforementioned exemplary embodiments, developing the substrate, and performing other well-known processes.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-200906 filed Aug. 1, 2007, which is hereby incorporated by reference herein in its entirety.

What is claimed is:

1. A driving apparatus for driving an object in a vacuum environment, the driving apparatus comprising:
a first chamber whose interior is maintained in a vacuum environment, the first chamber including a partition wall;
a stator that includes at least one coil, the stator having an upper surface that is part of the partition wall; and
a mover that includes at least one magnet and that is configured to load the object, the mover configured to move along the upper surface of the stator in a non-contact state therewith by applying an electric current to the at least one coil.

2. The driving apparatus of claim 1, wherein the at least one coil is arranged outside of the first chamber.

3. The driving apparatus of claim 1, further comprising a second chamber whose interior is maintained in a vacuum environment, wherein the stator is arranged inside the second chamber.

4. The driving apparatus of claim 3, further comprising a pressure adjustment unit configured to adjust a pressure inside the second chamber.

5. The driving apparatus of claim 1, wherein the partition wall of the first chamber has a bellows connected to the stator.

6. The driving apparatus of claim 1, further comprising:
a base configured to support the stator; and
a guide unit configured to guide movement of the stator to the base.

7. The driving apparatus of claim 1, further comprising a driving unit configured to drive a mass body so as to exert a force on the stator for resisting a force that the mover exerts on the stator, wherein the driving unit is arranged outside of the first chamber.

8. An exposure apparatus for exposing a substrate to a pattern formed on an original plate, the exposure apparatus comprising the driving apparatus for driving an object in a vacuum environment of claim 1, wherein the object is one of the original plate and the substrate.

9. A method for manufacturing a device comprising:
using the exposure apparatus of claim 8 to expose the substrate to the pattern formed on the original plate; and
developing the exposed substrate.

10. The driving apparatus of claim 3, wherein the second chamber includes a second partition wall, and wherein side and bottom portions of the stator are part of the second partition wall.

11. The driving apparatus of claim 10, further comprising pressure adjustment unit configured to adjust a pressure inside the first chamber and the second chamber.

12. An exposure apparatus for exposing a substrate to a pattern formed on an original plate, the exposure apparatus comprising the driving apparatus for driving an object of claim 10, wherein the object is one of the original plate and the substrate.

13. A method for manufacturing a device comprising:
using the exposure apparatus of claim 12 to expose the substrate to the pattern formed on the original plate; and
developing the exposed substrate.

14. The driving apparatus of claim 10, wherein the mover includes at least one hydrostatic bearing, wherein the mover moves along the upper surface of the stator in a non-contact state therewith by ejecting a gas from the at least one hydrostatic bearing.

15. An exposure apparatus for exposing a substrate to a pattern formed on an original plate, the exposure apparatus comprising the driving apparatus for driving an object of claim 14, wherein the object is one of the original plate and the substrate.

16. A method for manufacturing a device comprising:
using the exposure apparatus of claim 15 to expose substrate to the pattern formed on the original plate; and
developing the exposed substrate.

17. The driving apparatus of claim 1, wherein the stator includes a plurality of coils, the mover includes a plurality of magnets, and the mover is configured to move along the upper surface of the stator in a non-contact state therewith by applying an electric current to the plurality of coils.
